(19) United States
(12) Patent Application Publication
(10) Pub. No.: US 2006/0242689 A1
(43) Pub. Date: Oct. 26, 2006

(54) Storage apparatus and management module therefor

(75) Inventor: Kazuo Nakashima, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/208,771

(22) Filed: Aug. 22, 2005

(30) Foreign Application Priority Data
Apr. 20, 2005 (JP) 2005-122665

(51) Int. Cl. H04L 9/32

(52) U.S. Cl. 726/6

(57) ABSTRACT

A management module for a storage apparatus includes a device attribute managing part to manage attribute information and security function of at least two storage parts of different kinds and/or with different performances that are virtually used as a single virtual storage apparatus, and to provide at least a portion of the attribute information with respect to a host unit. The attribute information includes storage region information indicating a storage region occupied by each storage part in the virtual storage apparatus, and performance information of each storage part, in correspondence with each other.

### BACKGROUND OF THE INVENTION

1. Field of the Invention

The present invention generally relates to storage apparatuses and management modules therefor, and more particularly to a storage apparatus that is capable of virtually using storage parts of different kinds and/or with different performances (or functions) as storage parts of the same kind and/or with the same performance (or function), and to a management module therefor.

2. Description of the Related Art

The number of kinds of storage apparatuses have increased due to a large variety of information and a large amount of information to be stored in the storage apparatuses. Recently, a virtual storage apparatus, which uses a plurality of storage parts such as hard disk drives (HDDs) as if they were a single storage apparatus, has been reduced to practice so as to improve the management efficiency of the storage parts.

The conventional virtual storage apparatus combined the same kind of storage parts to provide an extremely large storage capacity. However, attempts have recently been started on combining different kinds of storage parts to virtually use the different kinds of storage parts as storage parts of a single kind. For example, a virtual storage apparatus combining a semiconductor memory and an HDD has been proposed, where a high-speed access can be made to a file that is stored in the semiconductor memory.

On the other hand, from the point of security, a mechanism by which the user assigns a password to the storage part is utilized, in order to prevent information leak that may be caused by unauthorized use of the storage part by a third party. For example, the password may be an HDD password. The HDD password is set in the HDD. Even when the HDD is connected to another personal computer (PC), access to the information in the HDD is not permitted unless the correct HDD password is input, and thus, the HDD password is an effective countermeasure against the information leak from the individual HDD.

However, in the virtual storage apparatus which combines a plurality of storage parts to virtually use the plurality of storage parts as a single storage apparatus, even if each of the individual storage parts is provided with an access control function such as the password, no function is provided to centrally manage the access control functions of the plurality of storage parts. For this reason, the access control function must be set for each of the individual storage parts. As a result, a security breach may be generated due to the complexity in managing the access control functions and an error that may be made when setting the access control functions.

For example, a Japanese Laid-Open Patent Application No. 8-30395 proposes a magnetic disk apparatus that efficiently utilizes a nonvolatile memory as a data storage region of a host unit, by making a modification to allocate an address space allocated to a magnetic disk to the nonvolatile memory. In addition, a Japanese Laid-Open Patent Application No. 9-297659 proposes a storage apparatus that integrates an HDD and a flash memory.

But when the different kinds of storage parts and/or the storage parts having the different performances (or functions) are simply combined in the virtual storage apparatus, it is impossible to effectively bring out the characteristics of each of the storage parts, and there was a problem in that the performance of the virtual storage apparatus does not improve considerably contrary to expectations.

In addition, with regard to the security, even if each of the individual storage parts is provided with the access control function such as the password, no function is provided to centrally manage the access control functions of the plurality of storage parts. For this reason, the access control function must be set for each of the individual storage parts. As a result, there was a problem in that a security breach may be generated due to the complexity in managing the access control functions and an error that may be made when setting the access control functions or, by assembling in the virtual storage apparatus the individual storage parts that are not provided with the access control functions.

### SUMMARY OF THE INVENTION

Accordingly, it is a general object of the present invention to provide a novel and useful storage apparatus and management module therefor, in which the problems described above are suppressed.

Another and more specific object of the present invention is to provide a storage apparatus and a management module therefor, that can effectively bring out the characteristics of individual storage parts and/or ensure security even when using storage parts of different kinds and/or with different performances (or functions).

Still another object of the present invention is to provide a management module for a storage apparatus, comprising a device attribute managing part configured to manage attribute information of at least two storage parts of different kinds and/or with different performances that are virtually used as a single virtual storage apparatus, and to provide at least a portion of the attribute information with respect to a host unit, where the attribute information includes storage region information indicating a storage region occupied by each storage part in the virtual storage apparatus, and performance information of each storage part, in correspondence with each other. According to the management module of the present invention, it is possible to effectively bring out the characteristics of individual storage parts.

A further object of the present invention is to provide a management module for a storage apparatus, comprising a security control part configured to centrally manage each of at least two storage parts that are virtually used as a single virtual storage apparatus, by carrying out a setting and/or a control related to security of each of the storage parts, where the security control part is connectable to the storage parts. According to the management module according to the present invention, it is possible to ensure security even when using storage parts of different kinds and/or with different performances (or functions).

Another object of the present invention is to provide a storage apparatus comprising at least two storage parts of different kinds and/or with different performances that are virtually used as a single virtual storage apparatus; and a device attribute managing part configured to manage attribute information of each of the storage parts, and to provide at least a portion of the attribute information with respect to a host unit, where the attribute information includes storage region information indicating a storage region occupied by each storage part in the virtual storage apparatus, and performance information of each storage part, in correspondence with each other. According to the storage apparatus of the present invention, it is possible to effectively bring out the characteristics of individual storage parts.

Still another object of the present invention is to provide a storage apparatus comprising at least two storage parts that are virtually used as a single virtual storage apparatus; and a security control part configured to centrally manage each of the storage parts, by carrying out a setting and/or a control related to security of each of the storage parts. According to the storage apparatus of the present invention, it is possible to ensure security even when using storage parts of different kinds and/or with different performances (or functions).

Other objects and further features of the present invention will be apparent from the following detailed description when read in conjunction with the accompanying drawings.

### BRIEF DESCRIPTION OF THE DRAWINGS

FIG. 1 is a system block diagram showing an important part of a first embodiment of a storage apparatus according to the present invention;

FIG. 2 is a diagram showing a format of data acquired by an inquiry command;

FIG. 3 is a diagram showing a definition of device types;

FIG. 4 is a flow chart for explaining a measuring process;

FIG. 5 is a diagram showing a structure (address map) of a storage part that is replaced or added;

FIG. 6 is a diagram for explaining a case where a storage part is replaced by a storage part having a larger capacity;

FIG. 7 is a diagram for explaining a case where a storage part is replaced by a storage part having a smaller capacity;

FIG. 8 is a system block diagram showing an important part of a second embodiment of the storage apparatus according to the present invention;

FIG. 9 is a flow chart for explaining a first embodiment of a password registration;

FIG. 10 is a flow chart for explaining a second embodiment of the password registration;

FIG. 11 is a flow chart for explaining a third embodiment of the password registration; and

FIG. 12 is a flow chart for explaining an access lock release.

### DESCRIPTION OF THE PREFERRED EMBODIMENTS

In the present invention, a device attribute managing part is provided to utilize the characteristics of each of individual storage parts to an upper limit. The device attribute managing part has a function of managing attribute information of each of the individual storage parts that is under control of a virtual storage apparatus and provides the attribute information to a host unit. Hence, it is possible to bring out the characteristics of the storage parts forming the virtual storage apparatus, and to allocate information (or files) that are frequently used in a computer system to the high-speed storage parts, so that the performance is improved such as quick booting of an operating system (OS).

In addition, by providing a security control part for centrally managing each of the individual storage parts that is under the control of the virtual storage apparatus, it is possible to simplify the management of the security control and suppress the generation of security breaches.

A description will be given of embodiments of a storage apparatus according to the present invention and a management module therefor according to the present invention, by referring to the drawings.

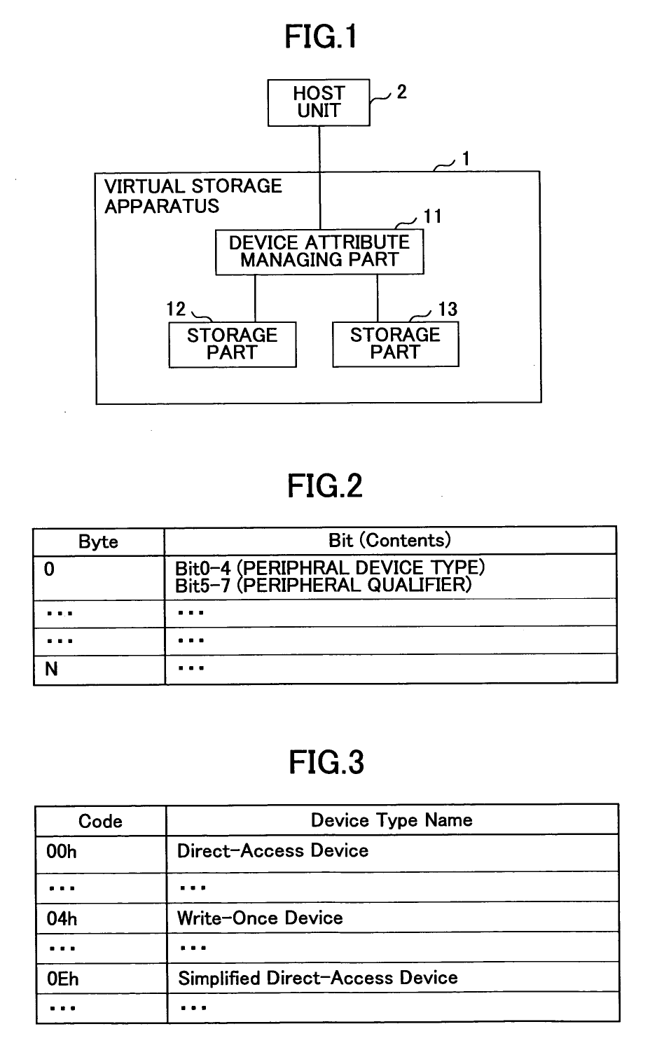

FIG. 1 is a system block diagram showing an important part of a first embodiment of the storage apparatus according to the present invention. In this embodiment, the present invention is applied to a virtual storage system.

As shown in FIG. 1, a virtual storage apparatus 1 includes a device attribute managing part 11 and a plurality of storage parts 12 and 13. The total number of storage parts 12 and 13 that are connectable within the virtual storage apparatus 1 is of course not limited to 2. The virtual storage apparatus 1 connects to a host unit 2 to form the virtual storage system. The host unit 2 is formed by a personal computer or the like, and instructs a read and/or a write (read/write) of information with respect to the virtual storage apparatus 1. The device attribute managing part 11 within the virtual storage apparatus 1 is formed by a processor such as a CPU and a memory, for example, and manages attribute information of the storage parts 12 and 13.

In FIG. 1, the virtual storage apparatus 1 has the device attribute managing part 11 and the plurality of storage parts 12 and 13 that are integrally packaged into a single package. However, storage units corresponding to the storage parts 12 and 13 and a management module including the device attribute managing part 11 may be provided independently and respectively connected to the host unit 2 or, the storage units may be connected to the host unit 2 via the management module. For example, the management module may be formed by a hardware package that includes at least a processor such as a CPU and a memory, or formed by a software package made up of a software or a driver that executes a program by use of the processor and the memory of the host unit 2 or the storage unit.

It is assumed for the sake of convenience that the storage part 12 is formed by a semiconductor memory device (hereinafter simply referred to as a memory), and the storage part 13 is formed by an HDD. A description will be given of the information that is managed by the device attribute managing part 11 for this case. In other words, the storage part 12 and 13 are different kinds of storage parts and have different performances (or functions) such as the read/write speeds and the storage capacities. The following Table 1 shows contents of an attribute management list that is stored in the memory within the device attribute managing part 11. The attribute management list includes a device attribute that indicates the existence of the read/write function, performance information including the read/write speed and the total number of blocks, and address range (or storage region) information indicating the address range (or storage region) occupied by each of the storage parts 12 and 13 within the virtual storage apparatus 1.

TABLE 1

| | | | | Address Range |
|---|---|---|---|---|
| | | | | Within Virtual |
| | Apparatus | Read/Write | Total No. | Storage |
| | Performance | Speed | of Blocks | Apparatus 1 |
| Memory 12 | Read/Write | High-Speed | 100 | 0 to 99 |
| HDD 13 | Read/Write | Medium-Speed | 300 | 100 to 399 |

From the attribute management list of the Table 1, it may be seen that the memory 12 which enables the high-speed read/write is used for the block addresses (BAs) 0 to 99 of the virtual storage apparatus 1, and the HDD 13 is used for the block addresses of 100 to 399. The device attribute managing part 11 can provide attribute information shown in the following Table 2 from the attribute management list of Table 1. As may be seen from the Table 2, the attribute information includes the address range (or storage region) information indicating the address range (or storage region) occupied by each of the storage parts 12 and 13 within the virtual storage apparatus 1, and performance information (read/write and read/write speed) of each of the storage parts 12 and 13, in correspondence with each other.

TABLE 2

| Address Range Within Virtual | | |
|---|---|---|
| Storage Apparatus 1 | Apparatus Attribute | Read/Write Speed |
| 0 to 99 | Read/Write | High-Speed |
| 100 to 399 | Read/Write | Medium-Speed |

From the attribute information shown in the Table 2, the host unit 2 can recognize that the read/write of the file can be carried out at the high speed for the block addresses 0 to 99. Hence, it is possible to arrange the files that are frequently accessed, with a priority over other less frequently accessed files, in the area having the block addresses 0 to 99, for example. As a result, it is possible to effectively utilize the characteristics of the individual storage parts 12 and 13 forming the virtual storage apparatus 1.

Next, a description will be given of a method of acquiring a read/write speed of a storage part that is replaced or added, when replacing or adding the storage part.

The virtual storage apparatus 1 confirms, immediately after the power is turned ON, whether or not the apparatus structure has been modified from the last time when the virtual storage apparatus 1 was used (that is, the previous use). If a modification of the apparatus structure from the previous use is detected, the virtual storage apparatus 1 reacquires the attribute information of each storage part, and forms the attribute management list again. In this case, it is assumed for the sake of convenience that a correspondence table of the write speed and the apparatus type (hereinafter referred to as a device type) of each storage part is prestored in the memory within the device attribute managing part 11, and that the write speed is determined with respect to the device type acquired from each storage part. The following Table 3 shows an example of the contents of the correspondence table.

TABLE 3

| Device Type | Read/Write Speed |
|---|---|
| Memory | High-Speed |
| HDD | Medium-Speed |
| CD-R | Low-Speed |

The device type may be acquired by issuing a SCSI inquiry command, for example. FIG. 2 is a diagram showing a format of data acquired by the inquiry command. The inquiry data format shown in FIG. 2 is in conformance with the SCSI Primary Commands (SPC) ANSI INCITS 301-1997. In FIG. 2, bits 0 to 4 of a byte 0 correspond to a field indicating the device type.

FIG. 3 is a diagram showing a definition of device types shown in FIG. 2. As shown in FIG. 3, the device type includes a code (device type code), a name (device type name) and the like. For example, if the storage part is an HDD, this device type can be judged from the device type code that is 00h or 0Eh. If the storage part is a write-once device such as a CD-R, this device type can be judged from the device type code that is 04h.

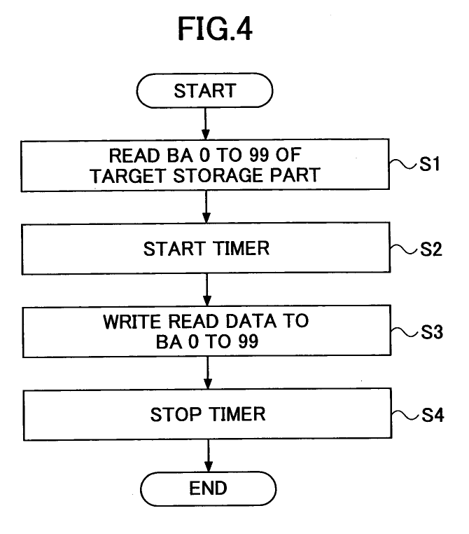

As another method of judging the write speed, it is possible to employ a method of carrying out a test write with respect to the device. In this case, a predetermined amount of data, such as several blocks or 1 MB, are written in the device, and the write speed is actually measured. FIG. 4 is a flow chart for explaining a measuring process for this case.

The measuring process shown in FIG. 4 may be carried out by the CPU within the device attribute managing part 11. In FIG. 4, a step S1 reads the data of the block addresses 0 to 99 of a target storage part, and a step S2 starts an internal timer of the CPU. A step S3 writes the data read in the step S1 to the block addresses 0 to 99 of the target storage part. A step S4 stops the internal timer of the CPU, and the process ends. The write speed is obtained based on the time that is measured by the internal timer of the CPU. The data read in the step S1 is written in the step S3, so as not to change the data that are stored in the target storage part by the test write.

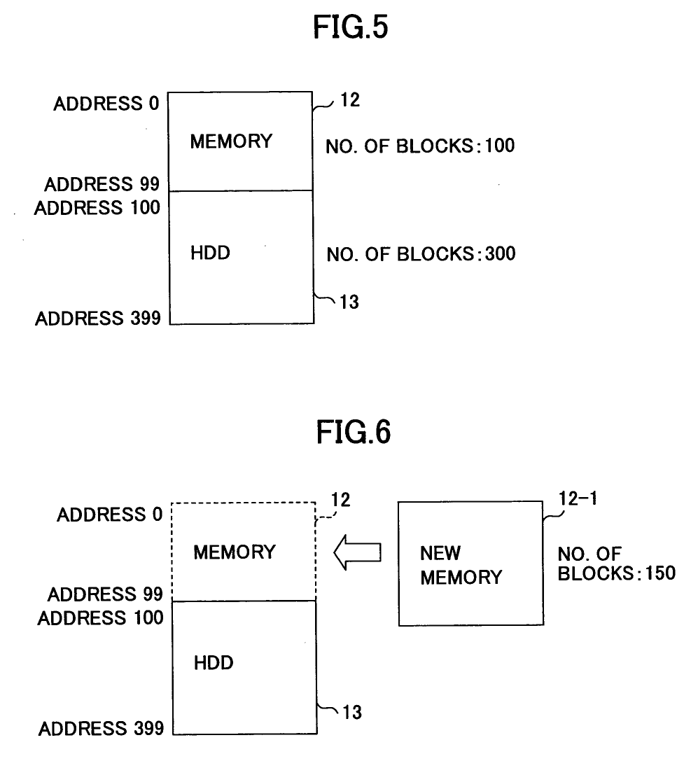

Next, a description will be given of a method of creating the attribute management list when replacing or adding the storage part, in a case where the storage capacity of the storage part that is replaced or added is different from that of the storage part existing before the replacement or addition. It is assumed for the sake of convenience that the storage parts 12 and 13 have a structure (that is, an address map) shown in FIG. 5. The storage part (memory) 12 has 100 block addresses 0 to 99, and the storage part (HDD) 13 has 300 block addresses 100 to 399. The attribute management list in this case includes the contents shown in the following Table 4.

TABLE 4

| | | | | | Address |
|---|---|---|---|---|---|
| | | | | | Range |
| | | | | | Within |
| | | | | | Virtual |
| | | | | Total | Storage |
| | Apparatus | Apparatus | Read/Write | No. of | Apparatus |
| | ID | Attribute | Speed | Blocks | 1 |
| Memory | M00001 | Read/Write | High-Speed | 100 | 0 to 99 |
| 12 | | | | | |
| HDD 13 | H00001 | Read/Write | Medium- | 300 | 100 to 399 |
| | | | Speed | | |

Suppose that the memory 12 that is originally connected in the virtual storage apparatus 1 is to be replaced by a new memory 12-1 having a size (memory capacity) larger than that of the memory 12. FIG. 6 is a diagram for explaining a case where the storage part is replaced by a storage part having a larger capacity. More particularly, FIG. 6 shows a case where the memory 12 having 100 block addresses is replaced by the new memory 12-1 having 150 block addresses.

If the address ranges in the attribute management list are combined for each storage part, the addresses of the HDD 13 that is not replaced will also be changed, as shown the following Table 5. More particularly, the block addresses 100 to 399 before the replacement are changed to the block addresses 150 to 449 after the replacement. In this case, when the data stored in the HDD 13 before the replacement are to be utilized, an inconvenience is introduced in that the access cannot be made to the data because the addresses will have been changed.

TABLE 5

| | | | | | Address |
|---|---|---|---|---|---|
| | | | | | Range |
| | | | | | Within |
| | | | | | Virtual |
| | | | | Total | Storage |
| | Apparatus | Apparatus | Read/Write | No. of | Apparatus |
| | ID | Attribute | Speed | Blocks | 1 |
| Memory | M00002 | Read/Write | High-Speed | 150 | 0 to 149 |
| 12-1 | | | | | |
| HDD 13 | H00001 | Read/Write | Medium- | 300 | 150 to 449 |
| | | | Speed | | |

Therefore, in order to eliminate the inconvenience described above, this embodiment creates the attribute management list as shown in the following Table 6. In other words, the address range of the new memory 12-1 that replaced the memory 12 is registered in divisions (or segments), namely, as a size identical to that before the replacement and a remaining size. As a result, the addresses of the HDD 13 will not be changed, and the data stored in the HDD 13 before the replacement can be utilized. As may be seen from the Table 6, the apparatus IDs of the storage parts 12-1 and 13 are also registered in the attribute management list, thereby making it possible to indicate that the memory 12-1 is registered in divisions. This is useful in that, when removing the memory 12-1, for example, it is possible to know the particular addresses (in this case, the addresses 0 to 99 and 400 to 499) that will be effected by the removal.

TABLE 6

| | | | | | Address |
|---|---|---|---|---|---|
| | | | | | Range |
| | | | | | Within |
| | | | | | Virtual |
| | | | | Total | Storage |
| | Apparatus | Apparatus | Read/Write | No. of | Apparatus |
| | ID | Attribute | Speed | Blocks | 1 |
| Memory | M00002 | Read/Write | High-Speed | 100 | 0 to 99 |
| 12-1 | | | | | |
| HDD 13 | H00001 | Read/Write | Medium- | 300 | 100 to 399 |
| | | | Speed | | |
| Memory | M00002 | Read/Write | High-Speed | 50 | 400 to 449 |
| 12-1 | | | | | |

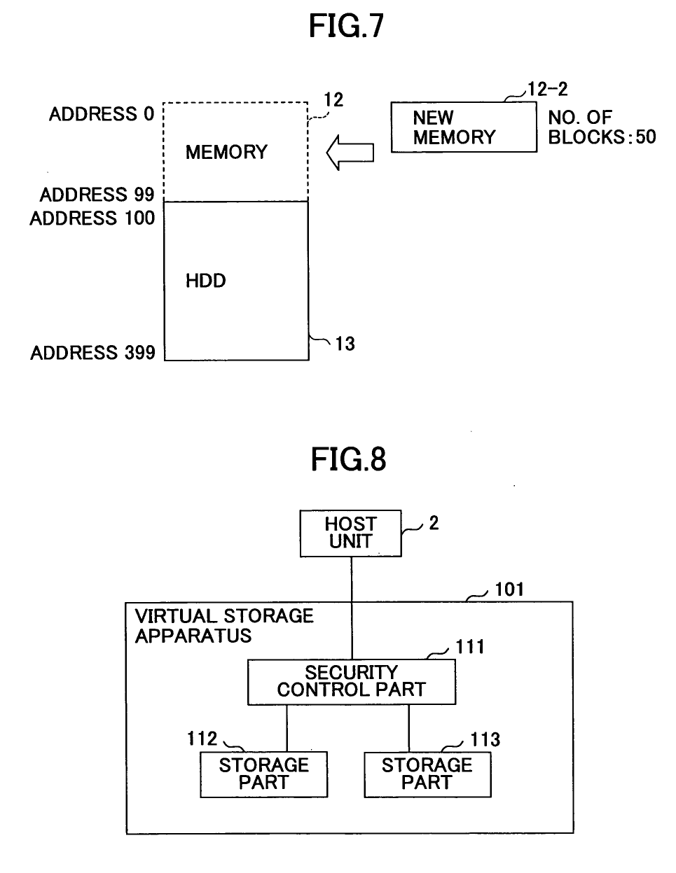

Next, suppose that the memory 12 that is originally connected in the virtual storage apparatus 1 is to be replaced by a new memory 12-2 having a size (memory capacity) smaller than that of the memory 12. FIG. 7 is a diagram for explaining a case where the storage part is replaced by a storage part having a smaller capacity. FIG. 7 shows a case where the memory 12 having 100 block addresses is replaced by the new memory 12-2 having 50 block addresses.

In this case, if the address ranges of the attribute management list were combined for each storage part, the addresses of the HDD 13 that is not replaced would also be changed as shown in the following Table 7. More particularly, the addresses 100 to 399 before the replacement will be changed to the addresses 50 to 349 after the replacement. In this case, when the data stored in the HDD 13 before the replacement are to be utilized, an inconvenience is introduced in that the access cannot be made to the data because the addresses will have been changed.

TABLE 7

| | | | | | Address |
|---|---|---|---|---|---|
| | | | | | Range |
| | | | | | Within |
| | | | | | Virtual |
| | | | | Total | Storage |
| | Apparatus | Apparatus | Read/Write | No. of | Apparatus |
| | ID | Attribute | Speed | Blocks | 1 |
| Memory | M00003 | Read/Write | High-Speed | 50 | 0 to 49 |
| 12-2 | | | | | |
| HDD 13 | H00001 | Read/Write | Medium- | 300 | 50 to 349 |
| | | | Speed | | |

Therefore, in order to eliminate the inconvenience described above, this embodiment creates the attribute management list as shown in the following Table 8. In other words, the insufficient address range (or insufficient memory capacity) of the new memory 12-2 that replaced the memory 12 is registered as a reserved area, so as to avoid a change in the addresses of the HDD 13. Consequently, the data stored in the HDD 13 before the replacement can be utilized after the replacement.

TABLE 8

| | | | | | Address |
|---|---|---|---|---|---|
| | | | | | Range |
| | | | | | Within |
| | | | | | Virtual |
| | | | | Total | Storage |
| | Apparatus | Apparatus | Read/Write | No. of | Apparatus |
| | ID | Attribute | Speed | Blocks | 1 |
| Memory | M00003 | Read/Write | High-Speed | 50 | 0 to 49 |
| 12-2 | | | | | |
| Reserved | — | — | — | 50 | 50 to 99 |
| HDD 13 | H00001 | Read/Write | Medium- | 300 | 100 to 399 |
| | | | Speed | | |

According to this first embodiment of the storage apparatus, it is possible to effectively bring out the characteristics, such as the read-write speed, of each of the individual storage parts.

FIG. 8 is a system block diagram showing an important part of a second embodiment of the storage apparatus according to the present invention. In this embodiment, the present invention is applied to a virtual storage apparatus. In FIG. 8, those parts which are the same as those corresponding parts in FIG. 1 are designated by the same reference numerals, and a description thereof will be omitted.

In FIG. 8, a virtual storage apparatus 101 has a security control part 111 and a plurality of storage parts 112 and 113 that are integrally packaged into a single package. However, storage units corresponding to the storage parts 112 and 113 and a management module (or control module) including the security control part 111 may be provided independently and respectively connected to the host unit 2 or, the storage units may be connected to the host unit 2 via the management module. For example, the management module may be formed by a hardware package that includes at least a processor such as a CPU and a memory, or formed by a software package made up of a software or a driver that executes a program by use of the processor and the memory of the host unit 2 or the storage unit.

As shown in FIG. 8, the virtual storage apparatus 101 includes the security control part 111 and the plurality of storage parts 112 and 113. The total number of storage parts 112 and 113 connectable within the virtual storage apparatus 101 is not limited to 2. The host unit 2 instructs a read and/or a write (read/write) of information with respect to the virtual storage apparatus 101, and also instructs a security control with respect to the virtual storage apparatus 101. The security control part 111 within the virtual storage apparatus 101 is formed by a processor such as a CPU and a memory, for example, and centrally manages the storage parts 112 and 113 by carrying out a setting and/or a control related to the security of the storage parts 112 and 113. The control of the security includes matching (or collating), setting and/or changing of a password. When describing the operation of the security control part 111, it is assumed for the sake of convenience that both the storage parts 112 and 113 are HDDs. In other words, the storage parts 112 and 113 are of the same kind, and the performances (or functions) of the storage parts 112 and 113 are the same or are different. The HDD password will be described as an example of the security function.

In a first embodiment of a password registration, an HDD password registration command is issued from the host unit 2 with respect to the virtual storage apparatus 101. The HDD password is “1111”, for example. The security control part 111 within the virtual storage apparatus 101 issues a password registration command separately with respect to the storage part (HDD) 112 and the storage part (HDD) 113 that are under the control of the security control part 111.

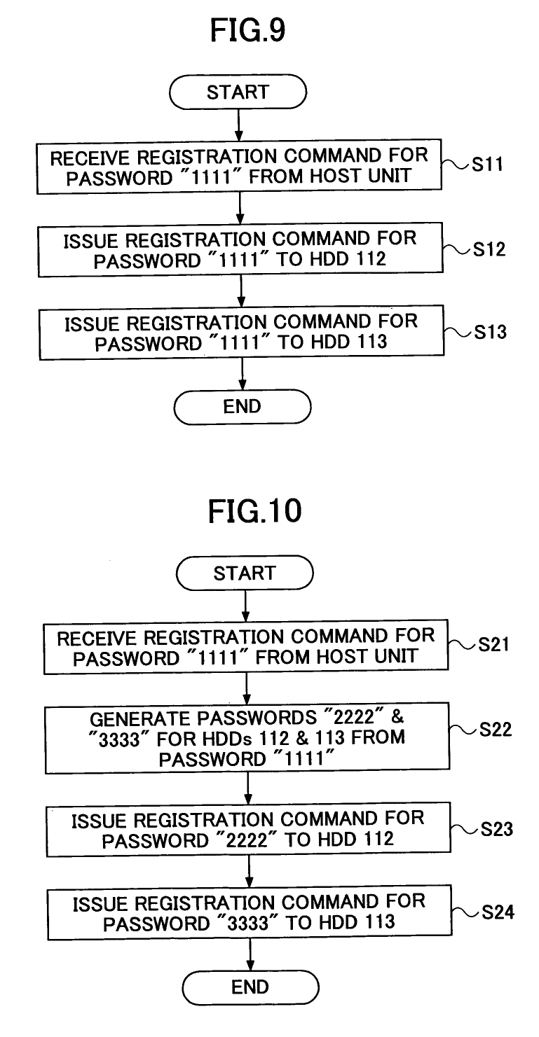

FIG. 9 is a flow chart for explaining this first embodiment of the password registration. The password registration process shown in FIG. 9 may be carried out by the CPU within the security control part 111. In FIG. 9, a step S11 receives a registration command for the HDD password “1111” issued from the host unit 2, and a step S12 issues a registration command for the HDD password “1111” with respect to the HDD 112. In addition, a step S13 issues a registration command for the HDD password “1111” with respect to the HDD 113, and the process ends.

In a second embodiment of the password registration, an HDD password registration command is issued from the host unit 2 with respect to the virtual storage apparatus 101. The HDD password is “1111”, for example. The security control part 111 within the virtual storage apparatus 101 issues a password registration command separately with respect to the HDD 112 and the HDD 113 that are under the control of the security control part 111. In this state, the security control part 111 subjects the HDD password received from the host unit 2 to a predetermined operation, so as to generate different HDD passwords for use with the HDDs 112 and 113. Hence, even if the password from the host unit 2 is stolen by an unauthorized third person, an access cannot be made to all of the HDDs 112 and 113 by use of the stolen HDD password, because the passwords are different for each of the HDDs 112 and 113, and the security is improved. When carrying out the predetermined operation, it is possible to use information peculiar to each individual HDD, so as to generate a unique password each time for each of the individual HDDs.

FIG. 10 is a flow chart for explaining this second embodiment of the password registration. The password registration process shown in FIG. 10 may be carried out by the CPU within the security control part 111. In FIG. 10, a step S21 receives a registration command for the HDD password “1111” issued from the host unit 2, and a step S22 generates HDD passwords “2222” and “3333” for the individual HDDs 112 and 113, respectively, by carrying out the predetermined operation with respect to the HDD password “1111”. A step S23 issues the HDD password “2222” with respect to the HDD 112. In addition, a step S24 issues the HDD password “3333” with respect to the HDD 113, and the process ends.

In a third embodiment of the password registration, consideration is given to a case where at least one of the storage parts forming the virtual storage apparatus 101 does not have the password function, when setting the password from the host unit 2 to the virtual storage apparatus 101. In such a case, when the password registration process is carried out without recognizing that a storage part not having the password function exists in the virtual storage apparatus 101, the access control cannot be made with respect to this storage part within the virtual storage apparatus 101, and the information leak may be generated if this storage part is stolen, for example. Hence, when carrying out the password registration process, this embodiment provides in the security control part 111 a function of confirming whether or not a predetermined password function is supported by each of the storage parts within the virtual storage apparatus 101. When this function provided in the security control part 111 detects a storage part that does not support the predetermined password function, the password registration process is discontinued and an error notification is made with respect to the host unit 2.

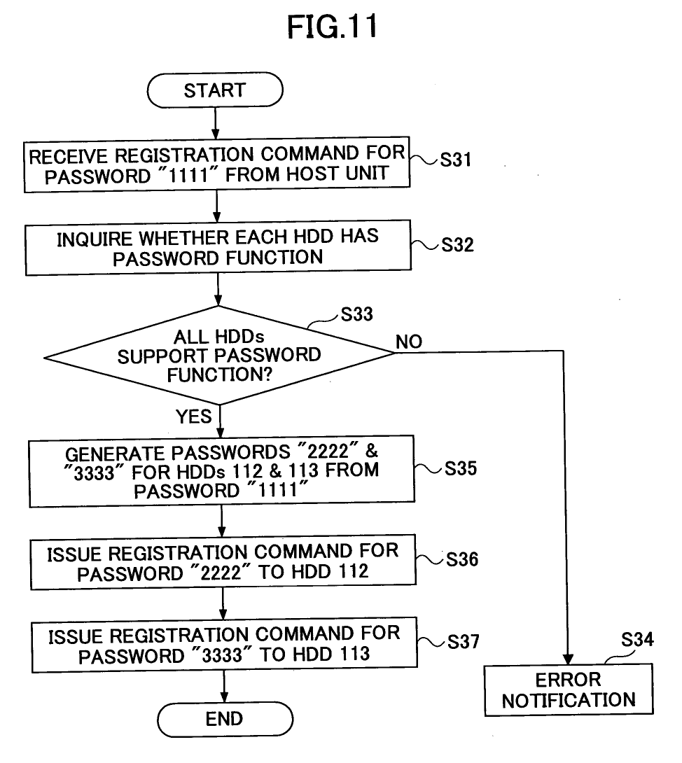

FIG. 11 is a flow chart for explaining a third embodiment of the password registration. The password registration process shown in FIG. 11 may be carried out by the CPU within the security control part 111. In FIG. 11, a step S31 receives a registration command for the HDD password “1111” issued from the host unit 2, and a step S32 inquires each of the HDDs 112 and 113 whether or not the password function is provided. A step S33 decides whether or not all of the HDDs 112 and 113 support the password function. If the decision result in the step S33 is NO, a step S34 makes an error notification with respect to the host unit 2.

On the other hand, if the decision result in the step S33 is YES, a step S35 generates HDD passwords “2222” and “3333” for the individual HDDs 112 and 113, respectively, based on the HDD password “1111”. A step S36 issues a registration command for the HDD password “2222” with respect to the HDD 112. In addition, a step S37 issues a registration command for the HDD password “3333” with respect to the HDD 113, and the process ends.

The matching (or collating) of the passwords can be realized by sending the HDD password received from the host unit 2 to each of the HDDs 112 and 113 from the security control part 111, similarly as in the case at the time of the password registration. In the first embodiment of the password registration described above, when the HDD password “1111” is received from the host unit 2, the security control part 111 sends the HDD password “1111” to each of the HDDs 112 and 113 that are under the control of the security control part 111.

In the second embodiment of the password registration described above, the security control part 111 carries out the predetermined operation with respect to the HDD password “1111” received from the host unit 2, and generates the HDD passwords “2222” and “3333” that are sent to the corresponding HDDs 112 and 113.

After sending the password, the security control part 111 attempts an access to both the HDDs 112 and 113, so as to confirm whether or not an access lock is released in a normal manner.

In a case where an illegitimate HDD password is sent from the host unit 2, an HDD password mismatch occurs in one or both of the HDDs 112 and 113 as a result of sending this illegitimate HDD password to the HDDs 112 and 113. In this case, it is possible to detect a release failure when confirming the release of the access lock, and the security control part 111 makes an error end (or abnormal end) with respect to a sector access type (read/write) command that is issued from the host unit 2.

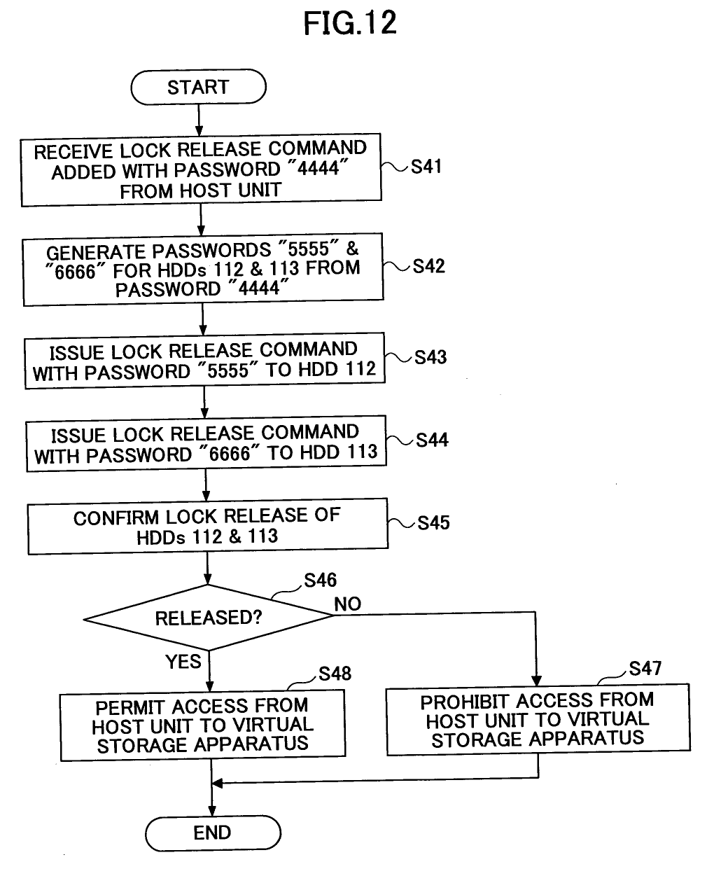

FIG. 12 is a flow chart for explaining an access lock release for a case where an erroneous password is sent from the host unit 2. The access lock release process shown in FIG. 12 may be carried out by the CPU within the security control part 111. In FIG. 12, a step S41 receives a lock release command that is added with an HDD password “4444” issued from the host unit 2, and a step S42 generates HDD passwords “5555” and “6666” for the individual HDDs 112 and 113, respectively, based on the HDD password “4444”. A step S43 issues a lock release command with the HDD password “5555” with respect to the HDD 112. In addition, a step S44 issues a lock release command with the HDD password “6666” with respect to the HDD 113.

A step S45 confirms the lock release of each of the HDDs 112 and 113, by carrying out a sector read. A step S46 decides whether or not the lock release is made in each of the HDDs 112 and 113. If the decision result in the step S46 is NO, a step S47 prohibits (that is, does not permit) the access from the host unit 2 to the virtual storage apparatus 101, and the process ends. On the other hand, if the decision result in the step S46 is YES, a step S48 permits the access from the host unit 2 to the virtual storage apparatus 101, and the process ends.

Accordingly, if an erroneous password is sent from the host unit 2, the security control part 111 cannot send legitimate (or correct) passwords with respect to the HDDs 112 and 113, and for this reason, the access lock of the HDDs 112 and 113 will not be released. Hence, the security control part 111 returns an error notification with respect to the sector access type command from the host unit 2, so as not to permit the access from the host unit 2 to the virtual storage apparatus 101.

According to this second embodiment of the storage apparatus, it is possible to ensure security even when using storage parts of different kinds and/or with different performances (or functions).

As a third embodiment of the storage apparatus according to the present invention, it is possible to combine the first and second embodiments of the storage apparatus described above. In this case, the virtual storage apparatus includes, in addition to the plurality of storage parts, both the device attribute managing part 11 shown in FIG. 1 and the security control part 111 shown in FIG. 8. It is also possible to realize the functions of both the device attribute managing part 11 and the security control part 111 by a structure that includes a processor such as a CPU and a memory.

According to this third embodiment of the storage apparatus according to the present invention, it is possible to effectively bring out the characteristics of such as the read/write speed of the individual storage parts, and simultaneously ensure security even when the storage parts of different kinds and/or with different performances (or functions) are used.

When a plurality of storage parts are connected to the virtual storage apparatus, it is possible to provide two modes that are selectable, so that all of the storage parts are virtually used as a single storage apparatus as in the case of the first and third embodiments in one mode, and the storage parts are grouped depending on the kinds and/or the performances of the storage parts as in the case of the conventional storage apparatus and each group is used as a separate storage apparatus in another mode.

In each of the embodiments of the storage apparatus described above, the HDDs and/or the semiconductor memory devices (memories) are used as the storage parts, but the storage parts are not limited to such devices. For example, an optical recording medium drive such as an optical disk drive or, a magneto-optical recording medium drive such as a magneto-optical disk drive, may be used in place of the HDD. Moreover, the semiconductor memory device is not limited to a particular type of memory, and various kinds of nonvolatile memories may be used.

This application claims the benefit of a Japanese Patent Application No. 2005-122665 filed Apr. 20, 2005, in the Japanese Patent Office, the disclosure of which is hereby incorporated by reference.

Further, the present invention is not limited to these embodiments, but various variations and modifications may be made without departing from the scope of the present invention.

What is claimed is:

1. A management module for a storage apparatus, comprising:
a device attribute managing part configured to manage attribute information of at least two storage parts of different kinds and/or with different performances that are virtually used as a single virtual storage apparatus, and to provide at least a portion of the attribute information with respect to a host unit,
said attribute information including storage region information indicating a storage region occupied by each storage part in the virtual storage apparatus, and performance information of each storage part, in correspondence with each other.

2. The management module as claimed in claim 1, wherein the performance information included in the attribute information includes a device attribute that indicates an existence of a read and/or write function, a read and/or write speed, and a total number of blocks.

3. The management module as claimed in claim 1, wherein the storage parts of different kinds and/or with different performances include at least a recording medium drive and a semiconductor memory device.

4. The management module as claimed in claim 1, further comprising:
a security control part configured to centrally manage each of the storage parts by carrying out a setting and/or a control related to security of each of the storage parts.

5. The management module as claimed in claim 4, wherein the security control part includes a part configured to confirm whether or not a security function is provided in each of the storage parts.

6. The management module as claimed in claim 4, wherein the security control part includes a part configured to make an error notification to the host unit when a storage part not having the security function is confirmed.

7. The management module as claimed in claim 4, wherein the security control part includes a part configured to judge whether or not an access lock with respect to each of the storage parts is released, and to permit an access from the host unit to the virtual storage apparatus only when the access lock with respect to each of the storage parts is released.

8. The management module as claimed in claim 4, wherein the device attribute managing part and the security control part are formed by a common processor.

9. A management module for a storage apparatus, comprising:
a security control part configured to centrally manage each of at least two storage parts that are virtually used as a single virtual storage apparatus, by carrying out a setting and/or a control related to security of each of the storage parts,
said security control part being connectable to the storage parts.

10. The management module as claimed in claim 9, wherein the security control part includes a part configured to confirm whether or not a security function is provided in each of the storage parts.

11. A storage apparatus comprising:
at least two storage parts of different kinds and/or with different performances that are virtually used as a single virtual storage apparatus; and
a device attribute managing part configured to manage attribute information of each of the storage parts, and to provide at least a portion of the attribute information with respect to a host unit,
said attribute information including storage region information indicating a storage region occupied by each storage part in the virtual storage apparatus, and performance information of each storage part, in correspondence with each other.

12. The storage apparatus as claimed in claim 11, further comprising:
a security control part configured to centrally manage each of the storage parts by carrying out a setting and/or a control related to security of each of the storage parts.

13. A storage apparatus comprising:
at least two storage parts that are virtually used as a single virtual storage apparatus; and
a security control part configured to centrally manage each of the storage parts, by carrying out a setting and/or a control related to security of each of the storage parts.
